(19) United States
(12) Patent Application Publication
(10) Pub. No.: US 2022/0229679 A1
(43) Pub. Date: Jul. 21, 2022

(54) MONITORING AND MAINTAINING HEALTH OF GROUPS OF VIRTUAL MACHINES

(71) Applicant: MICROSOFT TECHNOLOGY LICENSING, LLC, Redmond, WA (US)

(72) Inventors: Akshay Navneetlal MUTHA, Sammamish, WA (US); Abhishek Anil KAKHANDIKI, Bellevue, WA (US); Urim JUNG, Vineyard, UT (US); Eric RODRIGUEZ, Colleyville, TX (US); Niloofar HEZARJARIBI, Bellevue, WA (US); Ankita Sai SATYAVARAPU, Canton, MI (US)

(73) Assignee: MICROSOFT TECHNOLOGY LICENSING, LLC, Redmond, WA (US)

(21) Appl. No.: 17/150,010

(22) Filed: Jan. 15, 2021

(51) Int. Cl. G06F 9/455

(52) U.S. Cl. CPC G06F 9/45558; G06F 2009/45595; G06F 2009/45591

(57) ABSTRACT

Monitoring a health of a plurality of virtual machines operating within a group of virtual machines configured to implement an application includes receiving health information from each of the plurality of virtual machines during operation of the group of virtual machines, determining a health score for each of the plurality of virtual machines based on the received health information, establishing a priority queue ranking each of the plurality of virtual machines based on the determined health score thereof, identifying one or more unhealthy virtual machines based on the established priority queue, and sending a message to at least one of the identified unhealthy virtual machines over a communication network to remove the at least one of the identified unhealthy virtual machines from the group of virtual machines when a remaining number of virtual machines in the group of virtual machines is greater than a safety number.

### BACKGROUND

A virtual machine configured to implement a given application is typically considered to be healthy when the virtual machine is able to timely and efficiently fulfill, e.g., end user requests. Accordingly, a virtual machine that is not able to fulfill, e.g., end user requests may be considered unhealthy and in need of removal and/or self-healing. Typically, self-healing may include rebooting or replacement of the virtual machine. A technical problem that is addressed herein is that self-healing functionality is generally deployed on virtual machines dedicated to performing a same application may include removal of one or more virtual machines from operation in a random fashion. As a result of the random removal and/or self-healing of one or more virtual machines, a given virtual machine may be removed from operation even though the virtual machine may not be unhealthy, and/or may not be the worst (i.e., unhealthiest) virtual machine in the group in need to be removed. For example, if there are five (5) virtual machines within a group of virtual machines dedicated to implementing a given application, and only one (1) of the virtual machines can be removed and/or self-healed at a given time in order to avoid endangering the implementation of the application, the virtual machine that has the greatest need of removal and/or self-healing may not be the one that is randomly chosen. Accordingly, consistency in the health of the system constituted by a group of virtual machines may be compromised.

### SUMMARY

In one general aspect, the instant application describes a system for monitoring a health of a plurality of virtual machines operating within a group of virtual machines. The system includes a processor and a memory configured to executable instructions, which when executed by the process, cause the processor to perform functions of receiving, over a communication network, health information from each of the plurality of virtual machines, identifying one or more unhealthy virtual machines based on the received health information thereof, determining a health score for each of the plurality of virtual machines based on the received health information, establishing a priority queue ranking each of the identified one or more unhealthy virtual machines based on their health score, designating at least one of the unhealthy virtual machines to remove from the group, determining a number of remaining virtual machines based on the priority queue, comparing the number of remaining virtual machines to a safety number, the safety number indicating a minimum number of virtual machines necessary to implement an application, and, based on a result of comparing the number of remaining virtual machines to the safety number, sending a message to at least one of the unhealthy virtual machines over the communication network to remove the at least one of the unhealthy virtual machines from the group.

The above general aspect may include one or more of the following features. For example, to receive health information from a virtual machine, the memory further stores executable instructions which when executed by the processor cause the processor to perform functions of sending one of more health probes to the virtual machine over the communication network by the processor, each health probe monitoring an aspect of the virtual machine, each aspect having a health threshold and a base weight, and receiving a response to each health probe by the processor from the virtual machine over the communication network.

For another example, to determine the health score for a virtual machine, the memory further stores executable instructions which when executed by the processor cause the processor to perform functions of determining an over-threshold amount for each aspect based on the health threshold thereof and the received response, determining a probe weighted score for each aspect based on the base weight thereof and the over-threshold amount, and determining a health score of the virtual machine as a total weighted score based on a sum of the probe weighted scores of one or more of the aspects of the virtual machine.

For a further example, to determine the health score for a virtual machine, the memory further stores executable instructions which when executed by the processor cause the processor to perform functions of determining the over-threshold amount for an aspect as a difference between the obtained response and the health threshold for the aspect.

As an additional example, the memory stores instructions to cause the processor to establish the priority queue by ranking each virtual machine from highest total weighted score to lowest total weighted score. The memory may also store instructions to cause the processor to identify the one or more unhealthy virtual machines by identifying one or more unhealthy virtual machines having a total weighted score that is above a desired total weighted score. The memory may also store instructions to cause the processor to remove the identified one or more unhealthy virtual machines by removing the identified unhealthy virtual machines in inverse order of their respective total weighted scores.

For another example, to monitor the identified one or more unhealthy virtual machines during operation of the group of virtual machines, the memory stores instructions to cause the processor to determine the total weighted score thereof, designate one or more of the identified unhealthy virtual machines as new healthy virtual machines when the total weighted score thereof is better than a desired total weighted score, and include the designated new healthy virtual machines in the group of virtual machines.

In various implementations, the processor is housed on each of the virtual machines. Alternatively or additionally, the processor is housed on a terminal separate from the virtual machines, the terminal being part of the group of virtual machines, or a server separate from the virtual machines.

These general and specific aspects may be implemented using a system, a method, or a computer program, or any combination of systems, methods, and computer programs.

Additional advantages and novel features of these various implementations will be set forth in part in the description that follows, and in part will become more apparent to those skilled in the art upon examination of the following or upon learning by practice of the invention.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a flowchart illustrating a method of establishing a health score for a virtual machine, according to various implementations;

FIG. 2 is a flowchart illustrating a method of monitoring a health of a plurality of virtual machines operating within a group of virtual machines, according to various implementations;

FIG. 3 is a block diagram illustrating a group of virtual machines including a plurality of virtual machines, according to various implementations;

FIGS. 4A-4B are block diagrams illustrating a group of virtual machines including a plurality of virtual machines taken out of rotation, according to various implementations;

FIG. 5 is a table illustrating probes and baseweights for various health parameters, according to various implementations;

FIG. 6 is a table illustrating weighted score examples, according to various implementations;

FIG. 7 is a diagram illustrating a plurality of virtual machines in various states of health, according to various implementations;

FIG. 8 is a diagram illustrating a health maintenance operation, according to various implementations; and

FIGS. 9A-9C are diagrams illustrating a communication flow during the monitoring of the health of a plurality of virtual machines operating within a group of virtual machines, according to various implementations;

FIG. 10 is a block diagram illustrating an example of software architecture, various portions of which may be used in conjunction with various hardware architectures herein described; and

FIG. 11 is a block diagram illustrating components of an example of a machine configured to read instructions from a machine-readable medium and perform any of the features described herein.

### DETAILED DESCRIPTION

In the following detailed description, numerous specific details are set forth by way of examples in order to provide a thorough understanding of the relevant teachings. It will be apparent to persons of ordinary skill, upon reading this description, that various aspects can be practiced without such details. In other instances, well known methods, procedures, components, and/or circuitry have been described at a relatively high-level, without detail, in order to avoid unnecessarily obscuring aspects of the present teachings.

Healing virtual machines within a group of virtual machines that is performed in a random manner presents a technical problem because removal of one or more virtual machines from operation in a random fashion may result in either removing healthy virtual machines and leaving unhealthy virtual machines in operation, or removing less unhealthy machines and leaving more unhealthy machines in operation. In one specific example, an unhealthy virtual machine is a virtual machine that is not adequately able to respond to user demands.

To address these technical problems and more, in an example, this description provides a technical solution for identifying and removing the most unhealthy virtual machine(s) from operating within the group of virtual machines. Accordingly, the above technical problem may be avoided when only the unhealthiest machines are removed from operation. When the removed unhealthiest machines are no longer unhealthy, they may be rejoined to the group of virtual machines.

In various implementations, servers, also referred to herein as virtual machines, may be healed, e.g., automatically healed, based on a weighted score that is determined on the basis of a number of health metrics of the servers or virtual machines. These health metrics may reflect, e.g., the current ability of the servers or virtual machines to fulfill end user demands. The severity of unhealthiness of a virtual machine may be determined based on a weighted algorithm. The weights in the weighted algorithm may be configurable based on the importance of the related health metric. These operations may be performed during operation of the virtual machines, in real time.

In various implementations, the removal of a virtual machine, or self-healing operation, may be entirely, or substantially entirely, automated. The determination of the self-healing decision may be done in real-time, during operation of the virtual machine. A weighted algorithm may calculate the worst virtual machine in the group of virtual machines in real-time, or during operation of the group of virtual machines. The weights on the various health metrics used to evaluate the health of a given virtual machine may be configurable and may be changed when necessary or desired. The weights may be maintained in a priority queue that may be stored in a distributed cache and configured to make the decision across all the virtual machines whether to remove or keep a virtual machine in operation. The group of virtual machines may be consistently kept in its most healthy state.

Various implementations include implementing a priority queue within a group of virtual machines infrastructure to ensure that the unhealthiest machines may be taken out of rotation or operation. Instead of randomly selecting machines to be healed or removed, adding the priority queue may increase efficiency in the self-healing or removal process by consistently focusing on removing or self-healing the unhealthiest virtual machines.

Reference will now be made in detail to implementations, examples of which are illustrated in the accompanying drawings, wherein like reference numerals refer to the like elements throughout. In this regard, the present implementations may have different forms and should not be construed as being limited to the descriptions set forth herein. Accordingly, the implementations are merely described below, by referring to the figures, to explain various implementations of the present description.

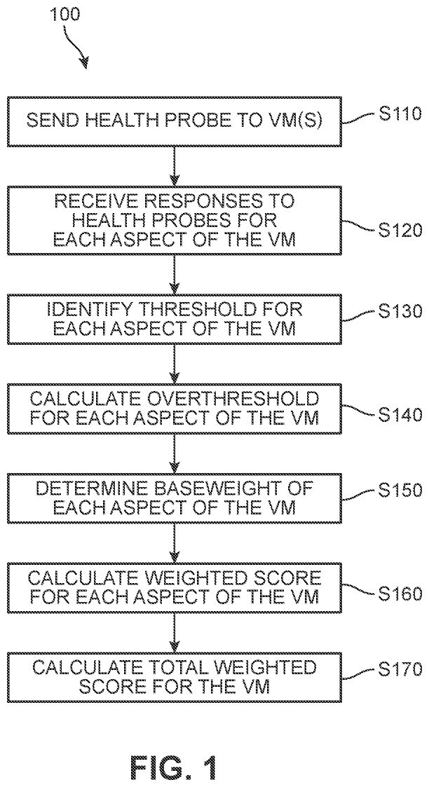

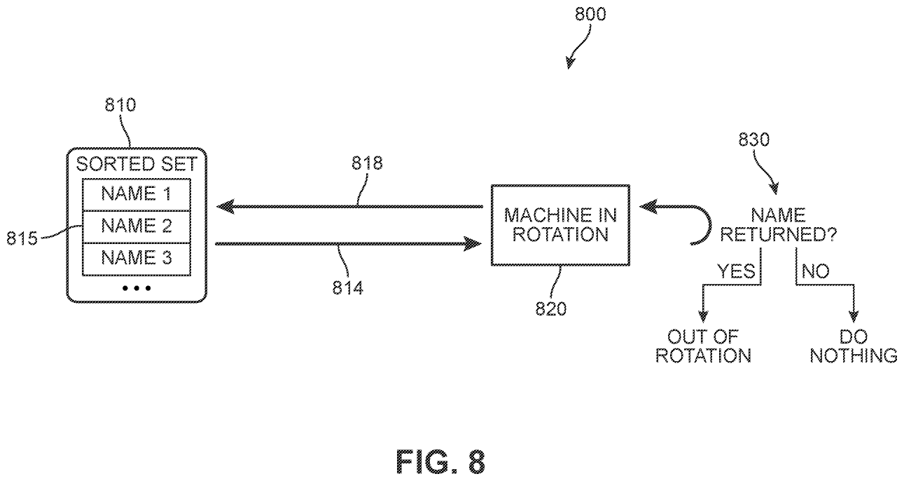

FIG. 1 is a flowchart illustrating a method 100 for establishing a health score for a virtual machine, according to various implementations. The various steps described below may be performed by a processor such as, for example, server 810 illustrated below in FIG. 8.

The process 100 starts at S110 where a health probe is sent to each, or to at least one, of the virtual machines constituting a group of virtual machines dedicated to implementing an application, e.g., a same application. In one implementation, the health probe is sent every five (5) seconds to the virtual machines. For example, a central server sends the health probes to each of the virtual machines. Alternatively, the virtual machines may send health probes to each other via processors located therein.

In S120, the health probes are responded to by the virtual machines and sent back to, for example, the central server. Each virtual machine may receive a plurality of health probes at S110, and upon receipt of the health probes, performs a check on a separate aspect of the health of the virtual machine, and replies to each health probe at S120. For example, a health probe may be a message configured to check the health of one aspect of the virtual machine. The health probes received may be stored in a data repository such as one or more of the virtual machines.

In S130, in various implementations, a threshold is identified for each aspect of the virtual machine by a processor. The threshold for one aspect may be different from the threshold of another aspect. Example thresholds may be threshold values for CPU usage, memory usage, and the like, under which the virtual machine may be considered to be unhealthy. The threshold of a given health aspect of a virtual machine provides a reference point based on which the health of the virtual machine with respect to a single aspect is evaluated. For example, if the health of the virtual machine is above the threshold, then the virtual machine may be considered to be healthy. Alternatively, the threshold may be determined so that if the health of the virtual machine is above the threshold, then the virtual machine may be considered to be unhealthy. Furthermore, the difference between the health of a given aspect of the virtual machine and the threshold for the same aspect determines the severity of unhealthiness of the given aspect of the virtual machine.

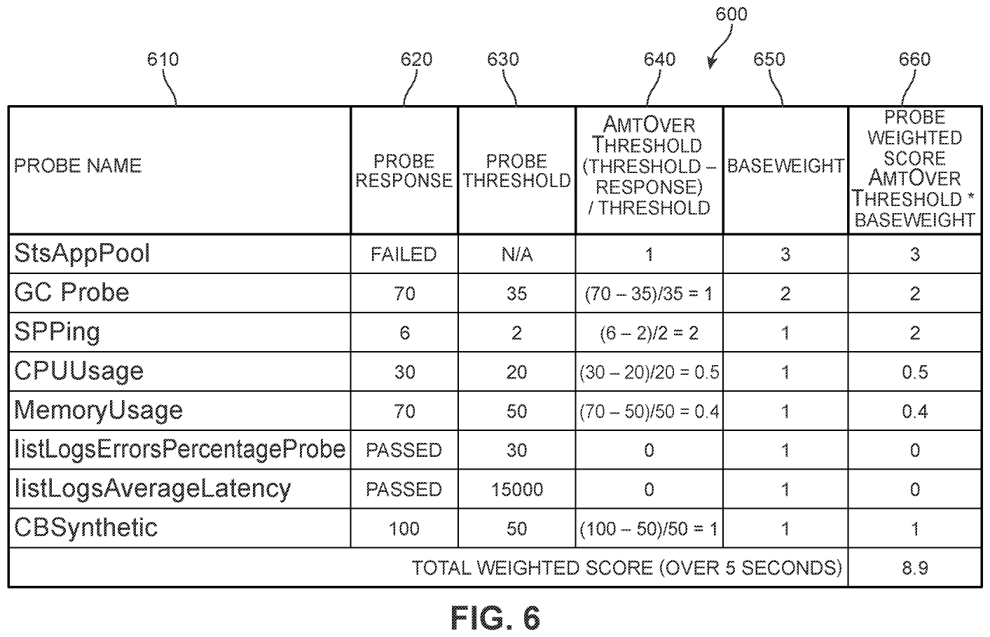

In S140, in various implementations, an amount over the threshold (“OverThreshold”) is calculated by a processor. The OverThreshold may be calculated as the ratio of the difference between the probe response and the threshold over the threshold for a given aspect of the health of a virtual machine, e.g., (response−threshold)/threshold or (threshold−response)/threshold. Example amounts of the OverThreshold are provided in Column 4 of FIG. 6. The amount of the OverThreshold provides an estimate of the severity of the unhealthiness of a virtual machine with respect to the specific aspect.

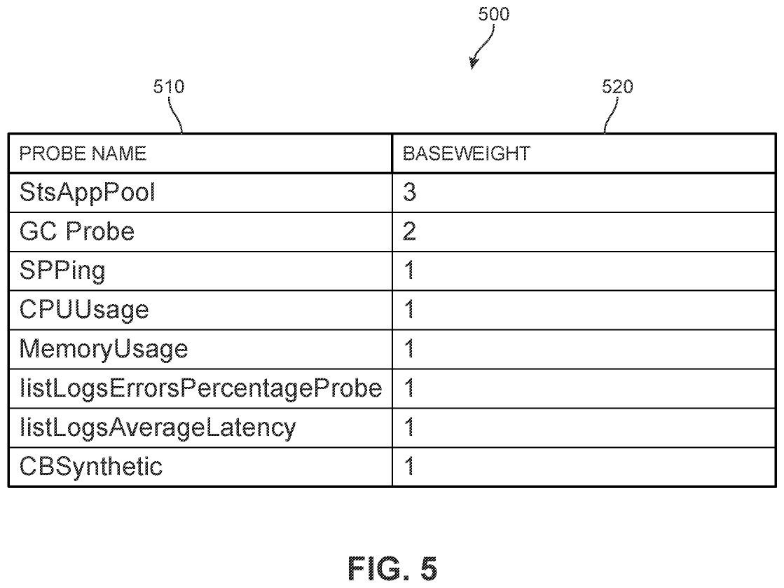

In S150, in various implementations, the Baseweight of each aspect for a given machine is determined by a processor. The Baseweight is specific to a given aspect, and provides an estimation of the relative importance of the health of a given aspect with respect to other aspects for the same machine. Example Baseweights are provided in FIG. 5 and FIG. 6 below. The Baseweights may be stored in a data repository.

In S160, in various implementations, a weighted score is calculated for each aspect of the virtual machine by a processor. The weighted score is calculated as the product of the Baseweight and the amount over the threshold. Example weighted scores are provided in Column 6 of FIG. 6. The weighted score for each aspect of a virtual machine may be stored in a data repository.

In S170, in various implementations, a total weighted score is calculated for the virtual machine in its entirety by a processor. The total weighted score for a given virtual machine is calculated as the sum of the weighted scores of each aspect of the given virtual machine. The total weighted score provides an indication of the overall health of the virtual machine. An example of a total weighted score for a given virtual machine is at the row of column 660 of FIG. 6. In the example illustrated in FIG. 6, the total weighted score is 8.9 and is calculated by a processor, as the sum of the individual weighted scores of each individual aspect of the same virtual machine. The total weighted score calculated as discussed above may be referred to as health score.

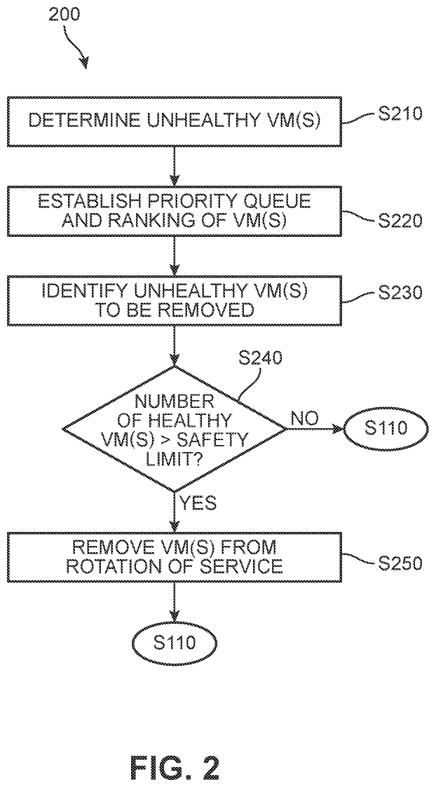

FIG. 2 is a flowchart illustrating a method 200 of monitoring a health of a plurality of virtual machines operating within a group of virtual machines, according to various implementations. The method 200 starts at S210, where one or more virtual machines are determined to be unhealthy, or sick, based on the responses to the health probes as discussed above with respect to S120. The one or more virtual machines are determined to be healthy by a processor if, e.g., their health probe result is above a certain threshold. A health probe result that is above a threshold of health may be considered to be unhealthy. Alternatively, a health probe result that is below the threshold may be considered to be unhealthy.

In various implementations, at S220, a priority queue is established for the virtual machines that have been determined at S210 to be unhealthy, the priority queue ranking the virtual machines based on their respective total weighted scores. The priority queue is established by a processor. For example, the least healthy virtual machine may be at the top of the queue, and each subsequently ranked virtual machine is healthier, or less unhealthy, than the one ranked immediately above, until the last queued virtual machine, which is the least unhealthy virtual machine of all the unhealthy virtual machines identified in S210. The priority queue is stored in a data repository.

In various implementations, at S230, based on the priority queue, one or more of the unhealthy machines identified in S210 are designated to be removed based on their total weighted score. For example, the virtual machine showing the highest unhealthiness is selected. The unhealthiest virtual machine is selected by a processor.

In various implementations, at S240, before removing an unhealthy virtual machine, a determination is made whether the number of remaining virtual machines is equal to or greater than a safety limit. The safety limit is the minimum number of virtual machines that can be active within a group without impeding the ability of the group to implement a given application. In other words, if the remaining number of virtual machines within the group, after having removed unhealthy virtual machines, would be lower than the safety limit, then the unhealthy virtual machine is not removed. The determination whether the number of remaining virtual machines is equal to or greater than the safety limit is performed by a processor.

In various implementations, if at S240 the processor, determines that the number of remaining healthy virtual machines is equal to or greater than the safety limit, then the method continues to S250, and the unhealthy virtual machine may be taken out of rotation. Subsequently to S250, the method continues to S110 to continue monitoring the group of virtual machines. If at S240 the processor, determines that the number of remaining healthy virtual machines is less than the safety limit, then the unhealthy virtual machine is kept in the rotation, and the method continues to S110 to continue monitoring the group of virtual machines.

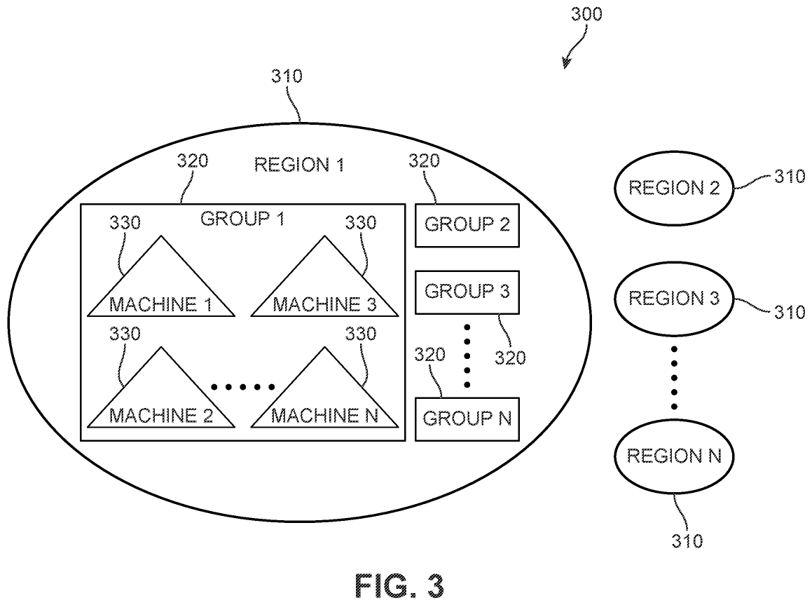

FIG. 3 is a block diagram 300 illustrating a group of virtual machines, according to various implementations. A number of virtual machines 330 are grouped together in groups 320 where the virtual machines 330 in each group 320 are configured to implement a same application. Each of the virtual machines 330 within the group 320 is configured to implement a common application, or each of the virtual machines 330 is configured to implement a portion of the application. FIG. 3 illustrates Groups 1, 2, 3 . . . n, 320 where each of the groups 320 includes a number of virtual machines 330. In the example illustrated in FIG. 3, all the groups 320 are dedicated to, for example, a given geographical region 310. Similarly, other regions 2, 3 . . . n 310 may also include a number of groups 320, each group 320 being dedicated to implementing a given application and including a number of virtual machines 330 configured to implement the given application or a portion thereof. If one of the virtual machines 330 is unhealthy, the unhealthy virtual machine 330 may be removed from the group 320 according to the method described above with respect to FIGS. 1 and 2.

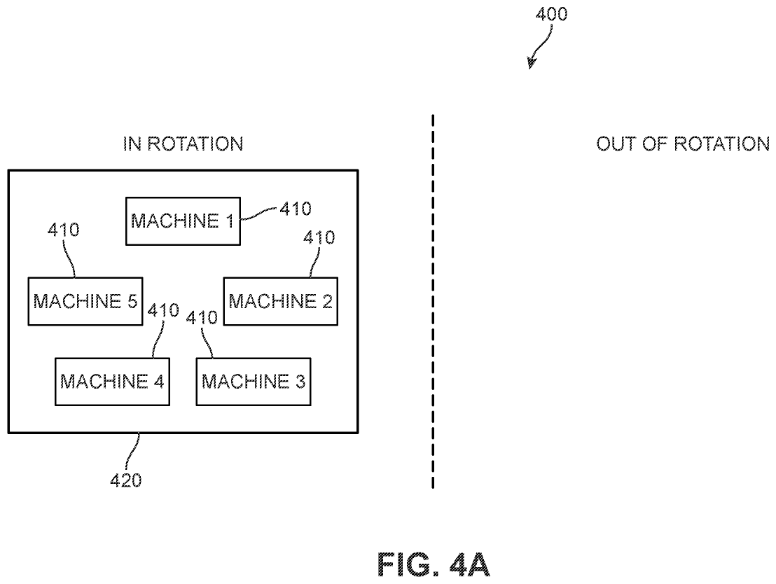

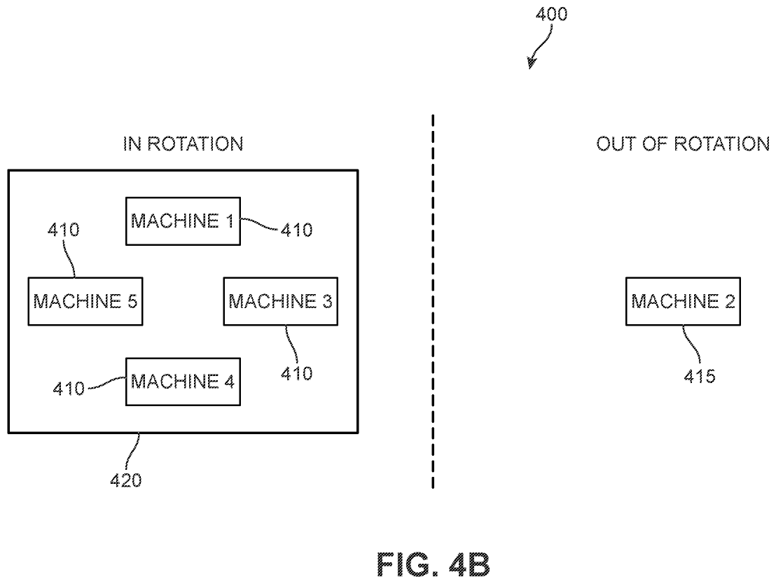

FIGS. 4A-4B are block diagrams 400 illustrating a group of virtual machines including a plurality of virtual machines taken out of rotation, according to various implementations. FIG. 4A illustrates a group 420 of virtual machines 410 that are in rotation. As the virtual machines 410 are in rotation, none of the virtual machines 410 has been found to be unhealthy according to the method described above with respect to FIGS. 1 and 2, thus none of the virtual machines 410 has been taken out of rotation. FIG. 4B illustrates a group 420 of virtual machines 410 that are in rotation, and one virtual machine 415, Machine #2, which was in rotation in FIG. 4A, has now been removed from the group 420 because virtual machine 415 (Machine #2) has been found to be unhealthy according to the method described above with respect to FIGS. 1 and 2. In FIG. 4B, virtual machine 415 (Machine #2) has been taken out of rotation in group 420 because it has been determined to be unhealthy according to the method described above with respect to FIGS. 1 and 2.

FIG. 5 is a table 500 illustrating various probes 510 and their corresponding Baseweights 520 for various health parameters, according to various implementations. In the table 500, each probe 510 includes a health check for one aspect of the virtual machine. The Baseweights 520 may include baseweights for checks for aspects of the health of the virtual machines, the aspects being or including, e.g., StsAppPool (checks whether the application pool is functioning correctly), GC Probe (garbage collection probe, which records how much memory is occupied with objects that are no longer in use by the program), SPPing (a ping that is sent to ensure that the machine is responding correctly), CPUUsage (an indication of the usage of the CPU of the virtual machine), MemoryUsage (an indication of the usage of the memory of the virtual machine), LisLogsErrorsPercentageProbe (checks how many errors are seen in the application logs), LisLogsAverageLatency (an indication of the average latency of the virtual machine), and CBSynthetic (checks whether the web application is working correctly and responding during a desired timeframe). As indicated in FIG. 5, each of the probes has a specific Baseweight that is independent of the others. The Baseweight assigned to each probe is exemplary and one of ordinary skill realizes that other Baseweight can be associated to each probe.

FIG. 6 is a table 600 illustrating weighted score examples, according to various implementations. In table 600, a weighted score 660 is calculated for each one of the probes 610 by a processor. For each one of the probes 610, a probe response 620 is received by a processor and is stored in a data repository. The probe response 620 may be a response to a health check. Each of the probes may have a probe threshold 630 associated therewith. The probe threshold 630 may also be stored in the data repository.

In various implementations, the amount over the threshold (“OverThreshold”) 640 is calculated, as discussed in S140 of the method illustrated above with respect to FIG. 1. The OverThreshold 640 of each aspect of each virtual machines is representative of the level of unhealthiness of the virtual machine, e.g. the larger the amount of OverThreshold 640, the more unhealthy the virtual machine may be. The OverThreshold 640 may be calculated by a processor and may be stored in the data repository. The Baseweights 650 for each of the probes, as determined at S150 of the method discussed above with respect to FIG. 1, may be used as a basis to calculate the weighted score 660, as indicated in S160 of FIG. 1. FIG. 6 lists all the calculated weighted scores 660 for each one of the probes 610. The sum of all the calculated probe weighted scores 660 is calculated, as discussed with respect to S170 in FIG. 1. The sum of the probe weighted scores 660 is listed as the total weighted score 670 and is illustrated on the last row of FIG. 6.

As an example, one of the probes 610 is “CPUUsage” and determines the health of the CPU usage for a given virtual machine. The probe response 620 received from the virtual machine is that its CPU usage is 30. The probe threshold 630 for CPU usage for this virtual machine is 20, indicating that the CPU usage of this virtual machine may be unacceptable because the probe response 620 is greater than the probe threshold 630, and this virtual machine may be unhealthy with respect to the aspect of CPU usage. The OverThreshold amount 640 can thus be calculated as (Threshold−Response)/Threshold, which translates to (30−20)/20, which generates an OverThreshold amount of 0.5. The Baseweight 650 for this virtual machine with respect to this probe is 1, so that the probe weighted score 660, being the product of the Baseweight 650 and the OverThreshold amount 640 is equal to (1×0.5=) 0.5.

As another example, one of the probes 610 is “MemoryUsage” and determines the health of the memory usage for a given virtual machine. The probe response 620 received from the virtual machine is that its memory usage is 70. The probe threshold 630 for memory usage for this virtual machine is 50, indicating that the memory usage of this virtual machine may also be unacceptable because the probe response 620 is greater than the probe threshold 630, and this virtual machine may be unhealthy with respect to the aspect of memory usage. The OverThreshold amount 640 can thus be calculated as (Threshold−Response)/Threshold, which translates to (70−50)/50, which generates an OverThreshold amount of 0.4. The difference between the threshold and the response provides an indication of the severity of the unhealthiness of the virtual machine. The Baseweight 650 for this virtual machine with respect to this probe is 1, so that the probe weighted score 660, being the product of the Baseweight 650 and the OverThreshold amount 640 is equal to (1×0.4=) 0.4. Similarly, probe weighted scores 660 for each aspect of the health of a virtual machine may be calculated. When all the probe weighted scores 660 are calculated, a total weighted score 670, which is the sum of all the probe weighted scores 660 of all health aspects of the virtual machine, may be calculated.

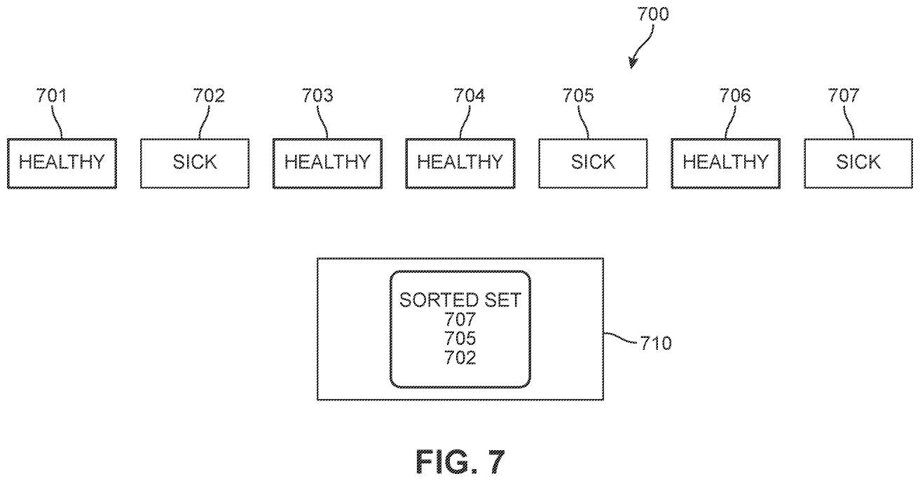

FIG. 7 is a diagram 700 illustrating a plurality of virtual machines in various states of health, according to various implementations. The health of each of the virtual machines 701-707 is evaluated, as indicated, e.g., at S210 of the method discussed above with respect to FIG. 2. In the example illustrated in FIG. 7, virtual machines 701, 703, 704 and 706 have been determined to be healthy, while virtual machines 702, 705 and 707 have been determined to be sick. The healthiness of the virtual machines 701-707 is determined by a processor. The degree of sickness of virtual machines 702, 705 and 707 varies, and a sorted set of virtual machines 710 is established. A processor ranks the virtual machines 702, 705 and 707 in order of severity of unhealthiness.

FIG. 8 is a diagram 800 illustrating a health maintenance operation, according to various implementations. In FIG. 8, a server 810 includes a data repository, and a sorted set of names or identifiers of unhealthy machines 815 is stored in the data repository. In various implementations, the server 810 may be or include a distributed cache, or may be a standalone server. Alternatively, the sorted set of unhealthy machines 815 may be stored in a memory of one or more of the virtual machines. The virtual machines 820 may include a processor and sends a communication message 818 via the processor and over a communication network to the server 810. The server 810 stores the content of the message 818 regarding the unhealthiness of the virtual machines and replies with a message 814 to the virtual machine 820, the message including the list of a number of virtual machines that have been found to be sick or unhealthy, e.g., the unhealthiest virtual machines ranked by the priority queue in the repository. In response to the message 814, the virtual machine 820 can determine the most unhealthy virtual machines. The virtual machine 820 may also send a query 830 to determine whether the virtual machine 820 is listed as one of the unhealthiest virtual machines from the message 814. If the query 830 returns a determination that the virtual machine 820 is one of the unhealthiest virtual machines, then the virtual machine 820 may be taken out of rotation. The virtual machine 820 can be taken out of rotation if the remaining number of virtual machines in the rotation is greater than the safety limit discussed above. If the query 830 returns a determination that the virtual machine 820 is not one of the unhealthiest virtual machines, then the virtual machine 820 is not taken out of rotation. Accordingly, the virtual machine 820 updates the data in the server 810 showing whether a virtual machine is out of rotation or still in rotation.

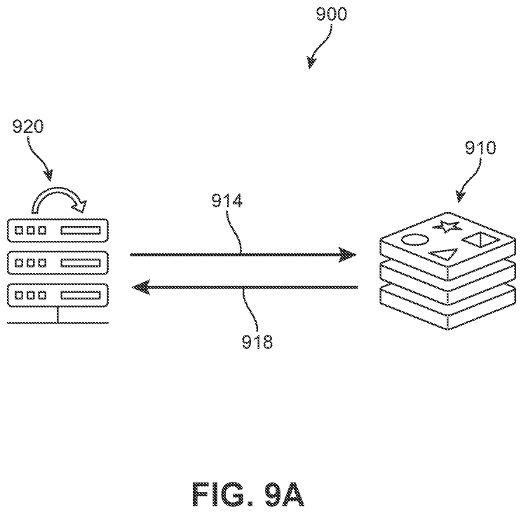

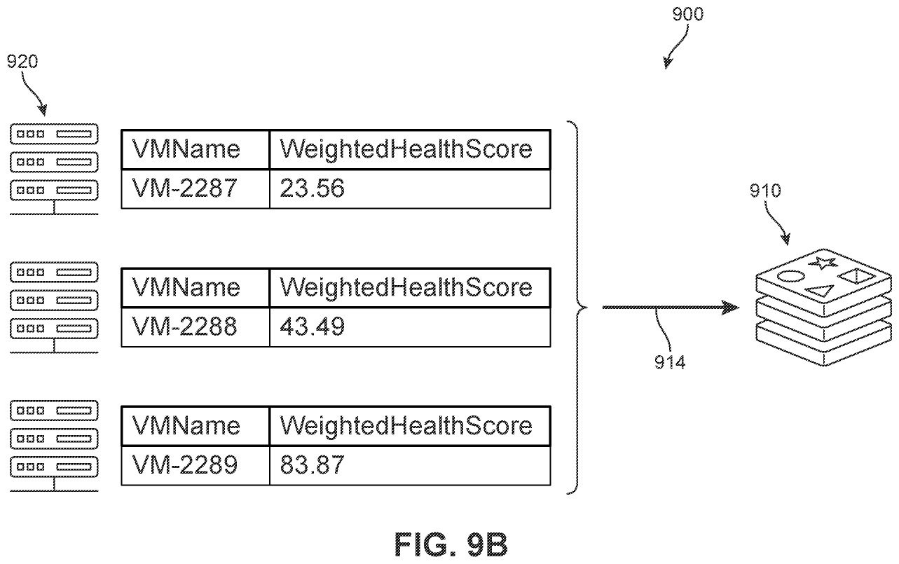

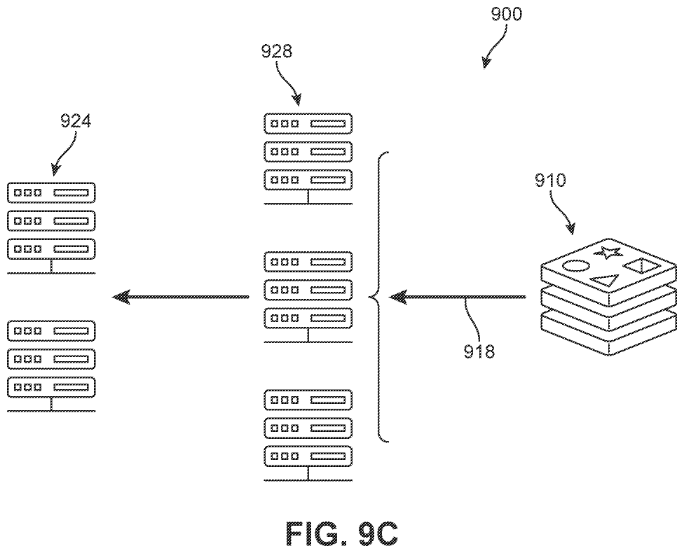

FIGS. 9A-9C are diagrams 900 illustrating a communication flow during the monitoring of the health of a plurality of virtual machines operating within a group and configured to implement a given application, according to various implementations. In FIG. 9A, a health check is performed on a virtual machine 920. The health check is performed every five (5) seconds, in one specific example. The virtual machine sends a message 914 to a server 910 indicating the weighted score of each health probe and/or the total weighted score for the virtual machine 920. The server 910 calculates a list of sick virtual machines via a processor. The server 910 determines, by forming a queue listing the virtual machines in rank of severity of sickness and by taking into account the safety limit of the minimum number of virtual machines that must remain active, which of the virtual machines can be taken out of circulation. The server 910 performs steps S110-S170 and S210-S250 discussed above with respect to FIGS. 1 and 2. Upon receipt of the instructions from the virtual machine 920, the virtual machines that are designated to be removed from the rotation of the group of virtual machines are then removed from the rotation.

FIG. 9B illustrates a plurality of virtual machines 920, each providing a weighted health score to a server 910 in a message 914. This step is similar to the step illustrated as 914 in FIG. 9A and corresponds to S110 illustrated in FIG. 1.

FIG. 9C illustrates a plurality of virtual machines 928, each requesting health information and receiving a return message 918 from a server 910 which keeps updated health data stored therein, the message 918 including a list of unhealthy virtual machines to be taken out of rotation. Based on the message 918, the sickest one of virtual machines 928 are taken out of rotation, leaving virtual machines 924 in the group of virtual machines. This step is similar to the step illustrated as 918 in FIG. 9A. If there is more than one unhealthy virtual machine in rotation, the number of machines to be taken out may be determined in view of the safety limit discussed above, because the virtual machines that remain in rotation may not be lower than the safety limit.

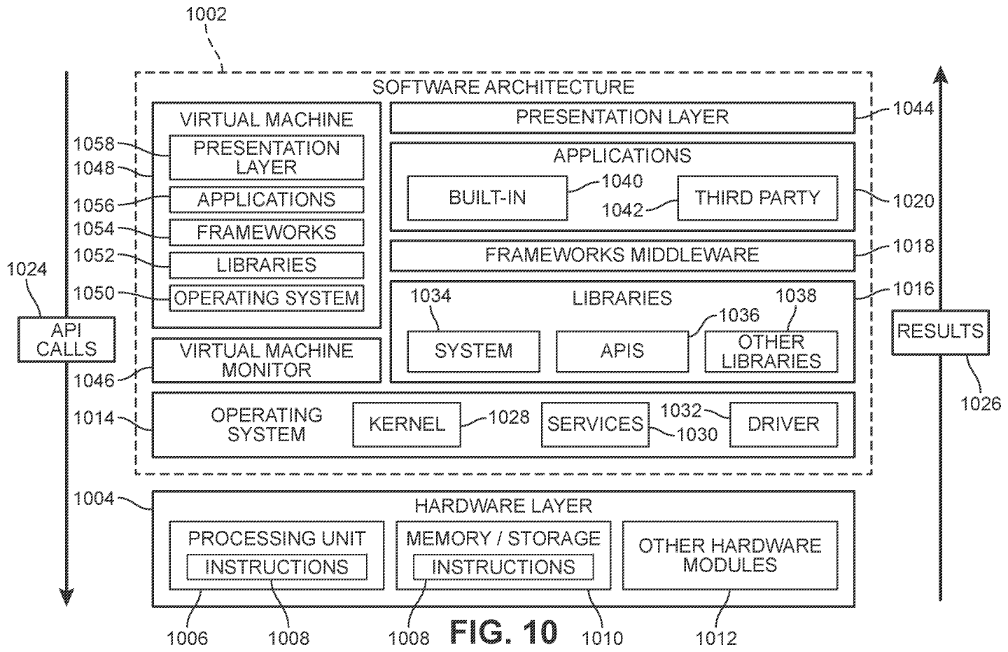

FIG. 10 is a block diagram 1000 illustrating an example software architecture 1002, various portions of which may be used in conjunction with various hardware architectures herein described such as, e.g., the groups 320 of virtual machines 330, which may implement any of the above-described features. FIG. 10 is a non-limiting example of a software architecture and it will be appreciated that many other architectures may be implemented to facilitate the functionality described herein. The software architecture 1002 may execute on hardware such as client devices, native application provider, web servers, server clusters, external services, and other servers. A representative hardware layer 1004 includes a processing unit 1006 and associated executable instructions 1008. The executable instructions 1008 represent executable instructions of the software architecture 1002, including implementation of the methods, modules and so forth described herein.

The hardware layer 1004 also includes a memory/storage 1010, which also includes the executable instructions 1008 and accompanying data. The hardware layer 1004 may also include other hardware modules 1012. Instructions 1008 held by processing unit 1006 may be portions of instructions 1008 held by the memory/storage 1010.

The example software architecture 1002 may be conceptualized as layers, each providing various functionality. For example, the software architecture 1002 may include layers and components such as an operating system (OS) 1014, libraries 1016, frameworks 1018, applications 1020, and a presentation layer 1044. Operationally, the applications 1020 and/or other components within the layers may invoke API calls 1024 to other layers and receive corresponding results 1026. The layers illustrated are representative in nature and other software architectures may include additional or different layers. For example, some mobile or special purpose operating systems may not provide the frameworks/middleware 1018.

The OS 1014 may manage hardware resources and provide common services. The OS 1014 may include, for example, a kernel 1028, services 1030, and drivers 1032. The kernel 1028 may act as an abstraction layer between the hardware layer 1004 and other software layers. For example, the kernel 1028 may be responsible for memory management, processor management (for example, scheduling), component management, networking, security settings, and so on. The services 1030 may provide other common services for the other software layers. The drivers 1032 may be responsible for controlling or interfacing with the underlying hardware layer 1004. For instance, the drivers 1032 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 1016 may provide a common infrastructure that may be used by the applications 1020 and/or other components and/or layers. The libraries 1016 typically provide functionality for use by other software modules to perform tasks, rather than rather than interacting directly with the OS 1014. The libraries 1016 may include system libraries 1034 (for example, C standard library) that may provide functions such as memory allocation, string manipulation, file operations. In addition, the libraries 1016 may include API libraries 1036 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 1016 may also include a wide variety of other libraries 1038 to provide many functions for applications 1020 and other software modules.

The frameworks 1018 (also sometimes referred to as middleware) provide a higher-level common infrastructure that may be used by the applications 1020 and/or other software modules. For example, the frameworks 1018 may provide various graphic user interface (GUI) functions, high-level resource management, or high-level location services. The frameworks 1018 may provide a broad spectrum of other APIs for applications 1020 and/or other software modules.

The applications 1020 include built-in applications 1040 and/or third-party applications 1042. Examples of built-in applications 1040 may include, but are not limited to, a contacts application, a browser application, a location application, a media application, a messaging application, and/or a game application. Third-party applications 1042 may include any applications developed by an entity other than the vendor of the particular system. The applications 1020 may use functions available via OS 1014, libraries 1016, frameworks 1018, and presentation layer 1044 to create user interfaces to interact with users.

Some software architectures use virtual machines, as illustrated by a virtual machine 1048. The virtual machine 1048 provides an execution environment where applications/modules can execute as if they were executing on a hardware machine. The virtual machine 1048 may be hosted by a host OS (for example, OS 1014) or hypervisor, and may have a virtual machine monitor 1046 which manages operation of the virtual machine 1048 and interoperation with the host operating system. A software architecture, which may be different from software architecture 1002 outside of the virtual machine, executes within the virtual machine 1048 such as an OS 1050, libraries 1052, frameworks 1054, applications 1056, and/or a presentation layer 1058.

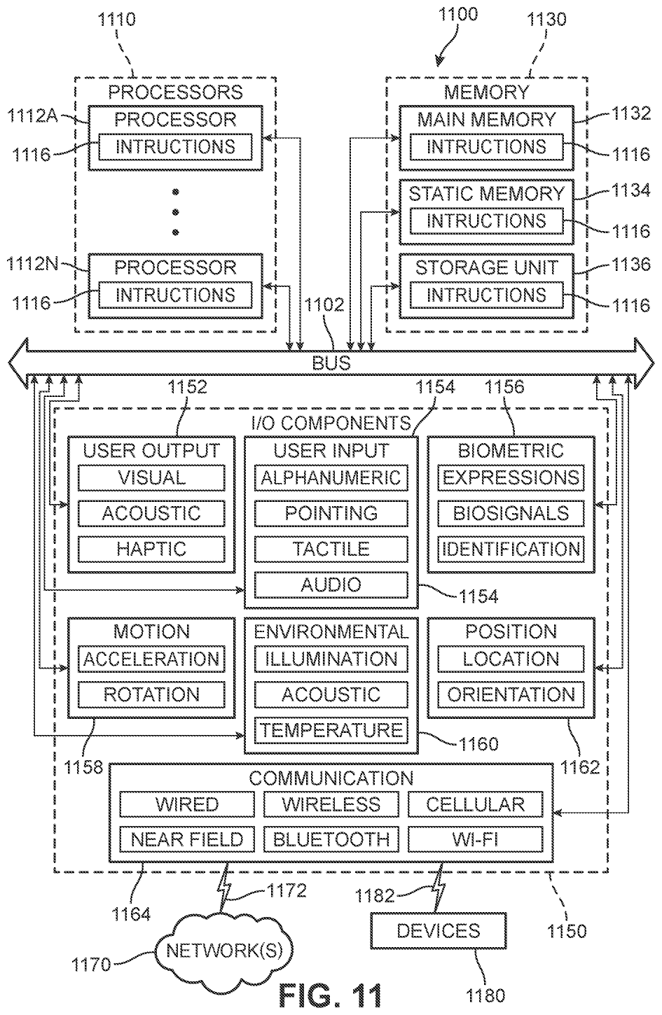

FIG. 11 illustrates components of an example machine 1100 configured to read instructions from a machine-readable medium (for example, a machine-readable storage medium) and perform any of the features described herein. In one example, the machine 1100 corresponds to virtual machine 330 shown and described in FIG. 3. The example machine 1100 is in a form of a computer system, within which instructions 1116 (for example, in the form of software components) for causing the machine 1100 to perform any of the features described herein may be executed. As such, the instructions 1116 may be used to implement methods or components described herein. The instructions 1116 cause unprogrammed and/or unconfigured machine 1100 to operate as a particular machine configured to carry out the described features. The machine 1100 may be configured to operate as a standalone device or may be coupled (for example, networked) to other machines. In a networked deployment, the machine 1100 may operate in the capacity of a server machine or a client machine in a server-client network environment, or as a node in a peer-to-peer or distributed network environment. Machine 1100 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 1100 is illustrated, the term “machine” includes a collection of virtual machines that individually or jointly execute the instructions 1116.

The machine 1100 may include processors 1110, memory 1130, and I/O components 1150, which may be communicatively coupled via, for example, a bus 1102. The bus 1102 may include multiple buses coupling various elements of machine 1100 via various bus technologies and protocols. In an example, the processors 1110 (including, for example, a central processing unit (CPU), a graphics processing unit (GPU), a digital signal processor (DSP), an ASIC, or a suitable combination thereof) may include one or more processors 1112a to 1112n that may execute the instructions 1116 and process data. In some examples, one or more processors 1110 may execute instructions provided or identified by one or more other processors 1110. The term “processor” includes a multi-core processor including cores that may execute instructions contemporaneously. Although FIG. 11 shows multiple processors, the machine 1100 may include a single processor with a single core, a single processor with multiple cores (for example, a multi-core processor), multiple processors each with a single core, multiple processors each with multiple cores, or any combination thereof. In some examples, the machine 1100 may include multiple processors distributed among multiple machines.

The memory/storage 1130 may include a main memory 1132, a static memory 1134, or other memory, and a storage unit 1136, both accessible to the processors 1110 such as via the bus 1102. The storage unit 1136 and memory 1132, 1134 store instructions 1116 embodying any one or more of the functions described herein. The memory/storage 1130 may also store temporary, intermediate, and/or long-term data for processors 1110. The instructions 1116 may also reside, completely or partially, within the memory 1132, 1134, within the storage unit 1136, within at least one of the processors 1110 (for example, within a command buffer or cache memory), within memory at least one of I/O components 1150, or any suitable combination thereof, during execution thereof. Accordingly, the memory 1132, 1134, the storage unit 1136, memory in processors 1110, and memory in I/O components 1150 are examples of machine-readable media.

As used herein, “machine-readable medium” refers to a device able to temporarily or permanently store instructions and data that cause machine 1100 to operate in a specific fashion. The term “machine-readable medium,” as used herein, does not encompass transitory electrical or electromagnetic signals per se (such as on a carrier wave propagating through a medium); the term “machine-readable medium” may therefore be considered tangible and non-transitory. Non-limiting examples of a non-transitory, tangible machine-readable medium may include, but are not limited to, nonvolatile memory (such as flash memory or read-only memory (ROM)), volatile memory (such as a static random-access memory (RAM) or a dynamic RAM), buffer memory, cache memory, optical storage media, magnetic storage media and devices, network-accessible or cloud storage, other types of storage, and/or any suitable combination thereof. The term “machine-readable medium” applies to a single medium, or combination of multiple media, used to store instructions (for example, instructions 1116) for execution by a machine 1100 such that the instructions, when executed by one or more processors 1110 of the machine 1100, cause the machine 1100 to perform and one or more of the features described herein. Accordingly, a “machine-readable medium” may refer to a single storage device, as well as “cloud-based” storage systems or storage networks that include multiple storage apparatus or devices.

The I/O components 1150 may include a wide variety of hardware components adapted to receive input, provide output, produce output, transmit information, exchange information, capture measurements, and so on. The specific I/O components 1150 included in a particular machine will depend on the type and/or function of the machine. For example, mobile devices such as mobile phones may include a touch input device, whereas a headless server or IoT device may not include such a touch input device. The particular examples of I/O components illustrated in FIG. 11 are in no way limiting, and other types of components may be included in machine 1100. The grouping of I/O components 1150 are merely for simplifying this discussion, and the grouping is in no way limiting. In various examples, the I/O components 1150 may include user output components 1152 and user input components 1154. User output components 1152 may include, for example, display components for displaying information (for example, a liquid crystal display (LCD) or a projector), acoustic components (for example, speakers), haptic components (for example, a vibratory motor or force-feedback device), and/or other signal generators. User input components 1154 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 1150 may include biometric components 1156, motion components 1158, environmental components 1160 and/or position components 1162, among a wide array of other environmental sensor components. The biometric components 1156 may include, for example, components to detect body expressions (for example, facial expressions, vocal expressions, hand or body gestures, or eye tracking), measure biosignals (for example, heart rate or brain waves), and identify a person (for example, via voice-, retina-, and/or facial-based identification). The position components 1162 may include, for example, location sensors (for example, a Global Position System (GPS) receiver), altitude sensors (for example, an air pressure sensor from which altitude may be derived), and/or orientation sensors (for example, magnetometers). The motion components 1158 may include, for example, motion sensors such as acceleration and rotation sensors. The environmental components 1160 may include, for example, illumination sensors, acoustic sensors and/or temperature sensors.

The I/O components 1150 may include communication components 1164, implementing a wide variety of technologies operable to couple the machine 1100 to network(s) 1170 and/or device(s) 1180 via respective communicative couplings 1172 and 1182. The communication components 1164 may include one or more network interface components or other suitable devices to interface with the network(s) 1170. The communication components 1164 may include, for example, components adapted to provide wired communication, wireless communication, cellular communication, Near Field Communication (NFC), Bluetooth communication, Wi-Fi, and/or communication via other modalities. The device(s) 1180 may include other machines or various peripheral devices (for example, coupled via USB).

In some examples, the communication components 1164 may detect identifiers or include components adapted to detect identifiers. For example, the communication components 1164 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 1162, such as, but not limited to, geo-location via Internet Protocol (IP) address, location via Wi-Fi, cellular, NFC, Bluetooth, or other wireless station identification and/or signal triangulation.

Generally, functions described herein (for example, the features illustrated in FIGS. 1-9) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

While various implementations have been described, the description is intended to be exemplary, rather than limiting, and it is understood that many more implementations and implementations are possible that are within the scope of the implementations. Although many possible combinations of features are shown in the accompanying figures and discussed in this detailed description, many other combinations of the disclosed features are possible. Any feature of any implementation may be used in combination with or substituted for any other feature or element in any other implementation unless specifically restricted. Therefore, it will be understood that any of the features shown and/or discussed in the present disclosure may be implemented together in any suitable combination. Accordingly, the implementations are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

While various implementations have been described, the description is intended to be exemplary, rather than limiting, and it is understood that many more implementations and implementations are possible that are within the scope of the implementations. Although many possible combinations of features are shown in the accompanying figures and discussed in this detailed description, many other combinations of the disclosed features are possible. Any feature of any implementation may be used in combination with or substituted for any other feature or element in any other implementation unless specifically restricted. Therefore, it will be understood that any of the features shown and/or discussed in the present disclosure may be implemented together in any suitable combination. Accordingly, the implementations are not to be restricted except in light of the attached claims and their equivalents. Also, various modifications and changes may be made within the scope of the attached claims.

What is claimed is:

1. A system for monitoring a health of a plurality of virtual machines operating within a group of virtual machines, the system comprising:
a processor; and
a memory configured to executable instructions, which when executed by the process, cause the processor to perform functions of:
receiving, over a communication network, health information from each of the plurality of virtual machines;
identifying, via the processor, one or more unhealthy virtual machines based on the received health information thereof;
determining, via the processor, a health score for each of the plurality of virtual machines based on the received health information;
establishing, via the processor, a priority queue ranking each of the identified one or more unhealthy virtual machines based on their health score;
designating, via the processor, at least one of the unhealthy virtual machines to remove from the group based on the priority queue;
determining, via the processor, a number of remaining virtual machines;
comparing the number of remaining virtual machines to a safety number, the safety number indicating a minimum number of virtual machines necessary to implement an application; and
based on a result of comparing the number of remaining virtual machines to the safety number, sending a message to at least one of the unhealthy virtual machines over the communication network to remove the at least one of the unhealthy virtual machines from the group.

2. The system of claim 1 wherein, to receive health information from a virtual machine, the memory further stores executable instructions which when executed by the processor causes the processor to perform functions of:
sending one of more health probes to the virtual machine over the communication network by the processor, each health probe monitoring an aspect of the virtual machine, each aspect having a health threshold and a base weight; and
receiving a response to each health probe by the processor from the virtual machine over the communication network.

3. The system of claim 2, wherein, to determine the health score for a virtual machine, the memory further stores executable instructions which when executed by the processor causes the processor to perform functions of:
determining an over-threshold amount for each aspect based on the health threshold thereof and the received response;
determining a probe weighted score for each aspect based on the base weight thereof and the over-threshold amount; and
determining a health score of the virtual machine as a total weighted score based on a sum of the probe weighted scores of one or more of the aspects of the virtual machine.

4. The system of claim 1, wherein the processor is housed on each of the virtual machines.

5. The system of claim 1, wherein the processor is housed on at least one of:
a terminal separate from the virtual machines, the terminal being part of the group of virtual machines; and
a server separate from the virtual machines.

6. A computer program product comprising a non-transitory computer usable medium having control logic stored therein for causing a computer to monitor a health of a plurality of virtual machines operating within a group of virtual machines configured to implement an application, the control logic comprising instructions for:
receiving, over a communication network, health information from each of the plurality of virtual machines over a communication network;
identifying one or more unhealthy virtual machines based on the received health information thereof;
determining a health score for each of the plurality of virtual machines based on the received health information;
establishing a priority queue ranking each of the identified one or more unhealthy virtual machines based on their health score;
designating at least one of the unhealthy virtual machines to remove from the group based on the priority queue;
determining a number of remaining virtual machines;
comparing the number of remaining virtual machines to a safety number, the safety number indicating a minimum number of virtual machines necessary to implement the application; and
based on a result of comparing the number of remaining virtual machines to the safety number, sending a message to at least one of the unhealthy virtual machines over the communication network to remove the at least one of the unhealthy virtual machines from the group.

7. The computer program product of claim 6, wherein the instructions for receiving health information from a virtual machine comprise instructions for:
sending one of more health probes to the virtual machine over the communication network, each health probe monitoring an aspect of the virtual machine, each aspect having a health threshold and a base weight; and
receiving a response to each health probe from the virtual machine over the communication network.

8. The computer program product of claim 6, wherein the instructions for determining the health score for a virtual machine comprise instructions for:
determining an over-threshold amount for each aspect based on the health threshold thereof and the received response;
determining a probe weighted score for each aspect based on the base weight thereof and the over-threshold amount; and
determining the health score of the virtual machine as a total weighted score based on a sum of the probe weighted scores of one or more of the aspects of the virtual machine.

9. A method of monitoring a health of a plurality of virtual machines operating within a group of virtual machines, the method comprising:
receiving, over a communication network, health information from each of the plurality of virtual machines;
identifying, via the processor, one or more unhealthy virtual machines based on the received health information thereof;
determining, via a processor, a health score for each of the plurality of virtual machines based on the received health information;
establishing, via the processor, a priority queue ranking each of the identified one or more unhealthy virtual machines based on their health score;
designating, via the processor, at least one of the unhealthy virtual machines to remove from the group based on the priority queue;
determining, via the processor, a number of remaining virtual machines;
comparing the number of remaining virtual machines to a safety number, the safety number indicating a minimum number of virtual machines necessary to implement an application; and
based on a result of comparing the number of remaining virtual machines to the safety number, sending a message to at least one of the unhealthy virtual machines over the communication network to remove the at least one of the unhealthy virtual machines from the group.

10. The method of claim 9, wherein the receiving health information from a virtual machine comprises:
sending one of more health probes to the virtual machine over the communication network, each health probe monitoring an aspect of the virtual machine, each aspect having a health threshold and a base weight; and
receiving a response to each health probe from the virtual machine over the communication network.

11. The method of claim 10, wherein the determining the health score for a virtual machine comprises:
determining an over-threshold amount for each aspect based on the health threshold thereof and the received response;
determining a probe weighted score for each aspect based on the base weight thereof and the over-threshold amount; and
determining the health score of the virtual machine as a total weighted score based on a sum of the probe weighted scores of one or more of the aspects of the virtual machine.

12. The method of claim 11, wherein the over-threshold amount for an aspect is determined as a difference between the obtained response and the health threshold for the aspect.

13. The method of claim 11, wherein the establishing the priority queue comprises ranking each virtual machine from highest total weighted score to lowest total weighted score.

14. The method of claim 11, wherein the identifying the one or more unhealthy virtual machines comprises identifying one or more unhealthy virtual machines having a total weighted score that is above a desired total weighted score.

15. The method of claim 11, wherein the removing the identified one or more unhealthy virtual machines comprises removing the identified unhealthy virtual machines in inverse order of their respective total weighted scores.

16. The method of claim 11, further comprising, during operation of the group of virtual machines:
monitoring the identified one or more unhealthy virtual machines by determining the total weighted score thereof;
designating one or more of the identified unhealthy virtual machines as new healthy virtual machines when the total weighted score thereof is better than a desired total weighted score; and
including the designated new healthy virtual machines in the group of virtual machines.

17. The method of claim 11, wherein a total weighted score of an unhealthy virtual machine is increased by at least one of rebooting the virtual machine and replacing the virtual machine.

18. The method of claim 9, wherein the message to the at least one of the unhealthy virtual machines is sent when the number of remaining virtual machines is equal to or greater than the safety number.

19. The method of claim 11, wherein the determining the over-threshold amount comprises calculating a difference between the received probe response and the health threshold, and dividing the difference by the health threshold.

20. The method of claim 19, wherein the determining the probe weighted score comprises multiplying the over-threshold amount with the base weight.
